(19) United States
(12) Patent Application Publication
(10) Pub. No.: US 2003/0115123 A1
(43) Pub. Date: Jun. 19, 2003

(54) Network and method for delivering active investing services for multiple subscribers

(76) Inventor: David A. Lang, New York, NY (US)

Correspondence Address: GOTTLIEB RACKMAN & REISMAN PC, 270 MADISON AVENUE, 8TH FLOOR, NEW YORK, NY, 100160601

(21) Appl. No.: 10/016,963

(22) Filed: Dec. 14, 2001

(51) Int. Cl. G06F 17/60

(52) U.S. Cl. 705/36

(57) ABSTRACT

A computer-based active investing network and method for gathering processing, displaying and transmitting information including a plurality of terminals linked by a communication system. The terminals are used by subscribers to enter and receive information in a flexibly-structured manner in response to a flexibly-ordered sequence of screens displayed for the purpose of opening and operating a brokerage or other investment account; subscribers can communicate and otherwise access and exchange information through the communication system. A database-server is used for receiving, processing and storing the information from multiple subscribers. The network may also include an communication module that processes information with respect to investment communications; a transaction module which processes information with respect to investment account operation; a securities compliance module for processing information with respect to subscriber qualification and statutory reporting requirements; a bridge program for integrating subscriber-entered information stored in the database with information and services from brokerage and clearing service providers and a bridge program for processing and transmitting information and used in complying with statutory filing and disclosure requirements.

### BACKGROUND OF THE INVENTION

A. Field of the Invention

The present invention relates to a computer-based investment network. More particularly to a network and method in which a plurality of subscribers can perform securities transactions, exchange information regarding specific securities, cooperate on a concerted project regarding a transaction and prepare appropriate public fillings related thereto, using a distributed architecture network such as the Internet.

B. Description of the Prior Art

Financial service industry is undergoing profound transition as electronic trading displaces traditional relationship-based compensation. Change is particularly acute in the investment industry. Technology is stimulating new competition by reducing the scale of business needed to be a full-service investment service provider. Concurrently, the expanding availability of public network communication, the increasing sophistication of networks processing and integration and the growing public acceptance of e-commerce business practices makes it possible to create and implement new industry practices and investment strategies. The current invention provides a means of formulating and conducting active investment strategies, discussed in more detail below.

Traditionally, investors wishing to invest in publicly traded stock companies are limited to passive stock ownership or indirect participation through mutual fund holdings. Such passive and indirect investors are limited in their ability to participate in corporate governance and thereby influence or control corporate managements. Except for an affluent few investors, financial and regulatory hurdles deter investors, including individuals and corporations, from exercising stockholder prerogatives such as communicating directly with other stockholders, coordinating stockholder voting with respect to corporate governance and 3^{rd} party initiatives, and consulting with respect to stock purchase and sale transactions.

The Internet is capable of transmitting investment information, opinions and transaction instructions. Yet intra-investor communication is constrained by disclosure requirements under the Securities Acts. Regulations require that investors with a beneficial interest exceeding 5% of the voting stock of a public company file periodic statements disclosing intentions with respect to the holding. Such investor is further obligated to disclose the name of other investors with whom he may coordinate investment in such company and the details of any related stock purchase and sale transactions. Regulations further impose certain limitations with respect to the timing and amount of transactions permissible with respect to such holding.

Regulations further require that any investor seeking to influence or control management disclose this intent through a public filing. This filing must be periodically updated to disclose the name of other investors with whom the investor may coordinate investment in such company and the details of any purchase and sale transactions.

Thus, regulations pose a burden that few investors endure and, as a result, there is little incentive for investors to share information. Similarly, there is no capacity to act cooperatively with respect to corporate governance processes.

### OBJECTIVES AND SUMMARY OF THE INVENTION

Accordingly, it is an objective of the present invention to provide a network and method that allows a group of investors with a common interest, for example, the shareholders of a corporation, to cooperate with each other to pursue a common goal, by participating in a active investing activity.

A further objective is to provide a venue by which outsiders, that is, individuals not connected with a corporation can initiate an action regarding a particular corporation, the action including fulfilling all regulatory requirements.

A further objective is to provide a network and method and allows a plurality of investors to exchange information through an action-linked dialogue about various investments to achieve superior investment returns.

A further objective is to provide a means which enables subscribers to communicate freely about their investments.

A further objective of the present invention is to reduce the burden of complying with various regulations, thereby stimulating intra-investor communication, cooperative investment research and active investment activity.

It is a further objective of this invention to enable subscribers to act in a concurrent investment style conditioned by intra-group communication.

It is a further objective of this invention to disclose a network including subscriber terminals, a web-enabled database-server(s), data bridges and a changeable selection of interactive and streaming communication flows.

This invention discloses a network and method that enables investors to communicate, coordinate, transact, and otherwise participate in corporate governance in a manner that is efficient and compliant with regulatory requirements, and thus allow individual investors to engage in what shall be referred to herein as Active Investing.

The concept of Active Investing is based on the premise that a group of qualified investors can cooperatively develop an information base and action plan independent of corporate management; that this information base includes a means to freely communicate and exchange information between subscribers as well as between subscribers and other interested parties.

Active Investing is based on the premise that registered investment professionals are seeking new methods for adding value for their investor clients.

Active investing is based on the premise that social and affinity investment advocates are seeking new methods of sustaining a constituency dialogue and supporting an information base.

Active Investing is based on the premise that corporate treasurers are seeking new methods for managing corporate investment portfolios.

Active Investing is based on the premise that technology combined with qualified fiduciary management can be effective in satisfying regulatory obligations

Active Investing is a niche strategy within the universe of investment alternatives. By its nature, it is an undiversified strategy and therefore carries above average risk. The corollary that it can deliver higher returns is undocumented. Despite this limitation, Active Investing offers Subscribers a novel investment utility.

An apparatus or network constructed in accordance with this invention comprises a plurality of terminals associated with subscribers, a distributed communications network adapted to interconnect the terminals, at least one database-server, a data storage element and a communication bridge. The network is used to perform certain processes defined by instructions resident in the database-server. The database-server maintains process indexes classifying activities of an active investing module, a transaction module and a securities compliance module.

The Active Investing method is comprised of three modules including the Communication module, the Transaction module and the Securities Compliance module.

The Communication module is comprised of the Communication Command and the active archive and links to complementary resources.

The Communication Command includes email, threaded message board and chat utilities. Communication options are arrayed in tabular menu in a manner of conventional Internet display, thereby permitting subscriber activity selection. Subscribers may access message boards and contribute comment and factual information thereto. Subscribers may access a Subscriber directory to identify Network participants and to selectively transmit email communications.

Information exchange methods are enabled by commercially available URL-based communication software and, for select exchanges, dedicated and secure communication bridges.

The Active Archive is comprised of documents and data templates applicable to Network and investment operations. Like the Communication Command, options available to Subscribers are arrayed in tabular menu in a manner of conventional Internet display. Such documents may include investment analyses and advisories, public filings, correspondence and security marketing materials. The templates may include forms for gathering Subscriber or account information, and compilations of financial data formatted in a manner that permits Subscriber manipulation and analyses. Also, the Archive may provide links to other Active Investing resources and external information.

The Transaction module processes investment account information, including tools to support investment analysis and portfolio decision-making and, through a Transaction Bridge, enables investment transactions and reporting.

The Securities Compliance module evaluates and records investor suitability and automates the principal administrative regulatory filing tasks.

To the inventor's knowledge, there is no mechanism whereby individual stockholders are able to conduct concurrent purchase and sale transactions, nor is there a mechanism, which collates such action in a manner suitable for regulatory filing obligations. The network of this invention creates such mechanisms.

The Communication module moderates subscriber communication with regard to investment information and strategy and provides guidance to the subscriber in devising transaction strategies.

The Transaction module integrates subscriber decisions with an electronic trading and commission billing means as widely provided by registered securities broker-dealers.

The Securities Compliance module processes information with respect to investor suitability, transactions & disclosures and regulatory filings.

In a preferred embodiment of this invention, the network further includes a chief workstation that enables an investment professional to use the Information, database-server, network and bridge elements for engaging, soliciting, monitoring, transacting and reporting in a manner consistent with investment professional's fiduciary duties to clients and others and to be compliant with applicable regulatory, government and stock exchange requirements.

It is thus a goal of this invention to enable Active Investing including the capability to communicate and consult with respect to investment transactions. It is also a goal of this invention to create independent investment research and analysis through the implementation of an active investment model. It is a further goal of this invention to enable regulatory compliance including fiduciary operations and mandated reporting of subscriber, account and statutory information.

The present invention achieves these goals by providing a password-controlled Network comprised of (I) Subscriber connections to a (ii) URL-based database-server including an (iia) Communications module, a (iib) Transaction module and a (iic) Securities Compliance module and a (iii) Chief Workstation and a (iv) communication network including bridges to information, transaction and compliance resources.

The subscriber connection may be any transmit/store/receive terminal operating on the Internet or a private network. The connection may be password controlled to provide for security and differentiated levels of service. The terminal may process information-using protocols downloaded from the database-server or a designated 3^{rd} party.

The URL-based communication network enables information exchange and offers information and investment services.

The database-server authenticates Subscriber connections and implements site protocols including but not limited to password control, directory and document controls, data and transaction security and Subscriber billing. Site protocols are processes managed by a Chief operating through a Chief Workstation.

The database-server is configured to support investment activity. The database is structured to accommodate financial service Entities and Attributes including verified identification, account registration information, investor wealth and income data, Subscriber preferences and disclosure information.

The Communication module includes subscriber communication processes, database search & document distribution utilities. These processes, utilities and tools are implemented through a Communication Command and an Active Document Archive and further include control processes managed by a Chief operating through a Chief Workstation

The Transaction module includes investment decision-making tools and electronic security brokerage portfolio services of conventional types.

The Securities Compliance module uses statutory and subscriber data, algorithms, schedules and transcripts to evaluate subscriber suitability, enable fiduciary review, satisfy statutory filing requirements, and perform document dissemination.

### BRIEF DESCRIPTION OF DRAWINGS

FIG. 1 is a block diagram showing hardware agents of the invention.

FIG. 2 is shows the various software elements of the invention associated with the main hardware components of the network of FIG. 1.

FIG. 3 is a generalized flow chart illustrating the operation of the subject network and method.

FIGS. 4A-D shows a chart listing the detailed steps for the preferred embodiment of the invention.

FIGS. 5A and 5B show typical menus that are displayed to a subscriber as part of the Active Investing activities.

### DETAILED DESCRIPTION OF THE INVENTION

Before describing the invention in detail, the following definitions are provided for a better understanding of the specification.

Account means an Entity enabled to perform investment transactions through the Active Investing Network.

An Active Investing Network is a network that allows a plurality of investors to (1) share information regarding investments; (2) trade securities (optional); and (3) act in concert to affect a desired outcome regarding a company or other issuer of securities.

Agent means apparatus and elements thereof used to conduct Active/Active Investing.

Attribute means a component of data that describes an Entity in terms of a characteristic the Entity can have and which is stored in a database.

Bridge means a documented and operational communication link with an External Agent. For example, the Compliance Bridge establishes a Data and Communication Flow between the Invention and the Securities & Exchange Commission, which is used to conduct statutory filings and regulatory oversight.

Chief means an Entity vested with investment and Network controls.

Chief Workstation means a terminal vested with investment and Network controls.

Communication command is a collection of communication utilities including a network directory, interactive group messaging services and a protocol control center.

Communication System means hardware and software associated therewith to effectuate of data flow.

Component means information or element not divided into smaller subcomponents or parts. Components include Entities, Attributes, Values, Status and data items that are not either. In a Process relating to Active Investing, “SUBSCRIBER” and “SALARY” could represent types of “Entities” and “Values”. “Attributes” for SUBSCRIBER could include “CLIENT ADDRESS” and ELECTRONIC SIGNATURE“. Status items might include STATUTORY ELIGIBILITY”. All these items are Components.

Communication Flow means displaying, exchanging, recording and reporting data required by Active Investing. Communication Flow is a form of Data Flow

Data Flow means data serving as input to or output from a Process or the flow of data within the Process itself. Data Flows are connected by Bridges to External Agents, networks and processes. Data Set means a combination of attributes and values & dates that define an Entity or group thereof.

Data Store means data produced by a given Process which is preserved or stored and is made available to other Processes or subsequent execution of said given Process. Data Store items combine as Data Flows to define and process Entities.

Document means Data Flow formatted for electronic or Subscriber review and distribution or formatted for External Agent processing.

Entity means a topic of data that is normally in the form of a natural or statutory person, thing, concept, or event about which Subscribers want to collect information. Entities are characterized, described, or modified by data referred to as Attributes, Values & Dates and Status. Each Subscriber is an Entity.

External Agent means a data store and process that is outside the Processes currently being disclosed, but exchanges service and information with the Active Investing Communication module, the Transaction module and the Securities Compliance module.

Filing means a document comprised of Account and Network information and formatted in a manner complying with securities law and industry practices.

Information is data accumulated to implement Active Investing Processes.

Menu is a graphic and/or audio representation used to gather and report Communication Flow.

Moderating is the creation, selection, redaction, authorization, publication and preservation of website materials and services.

Modules means functionally related components which perform associated functions and processes, which may be represented in a block diagram. Active Investing, transactions and securities compliance are processes that are performed by modules.

Network means URL-based Data Flow between Visitors, Subscribers, Accounts, Observers, Agents, Chief Workstation and External Agents. Network includes password & directory protocols to limit and differentiate Data Flow access.

An Observer is a registered user that can view data and other information on the network but does not participate in common activities or investment transactions.

Process means a defined business method, procedure, activity, or task that is repeatable. A process may be composed of one or more parent and offspring Processes. In a hierarchy of Processes, a single Process may be parent and offspring Processes. Parent Processes and offspring Processes are related in a hierarchy that provides successive layers of detail. Processes may be non-hierarchically combined

Requirements are data needed to perform or define a specified Process, such as enrolling Subscribers, qualifying suitability of investments for Subscribers, preparing and disseminating a statutory filing and other functions.

Status is a condition pertaining to an Entity arising from Data Flow processing by a Chief operating through a Chief Workstation.

Subscriber is a registered site user, which may be further designated Subscriber, Account and Observer.

Terminal may be a personal computer, a networked server or a wireless communication device enabled to transmit, store and process Active Investing Information.

Visitor is a person accessing select Network resources before he is identified by the network as a Subscriber or an Observer.

Hardware Configuration

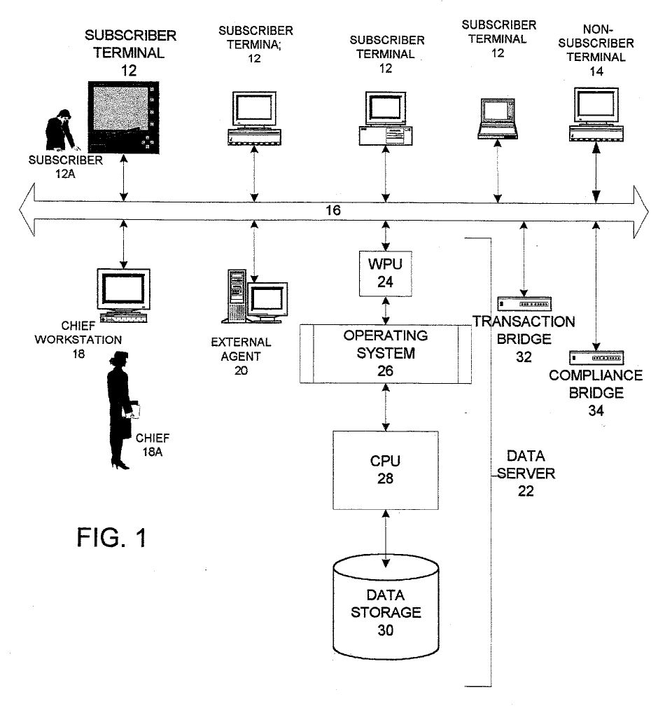

Referring to FIG. 1, a active investing network 10 is shown having subscriber terminals 12, and one or more non-subscriber (or observer) terminals 14 connected thereto through a distributed network interconnection system 16. Each terminal 12, 14 is an internet-enabled device and may comprise a personal computer, a networked server or a wireless communication device (such as a laptop, a cellphone, a hand-held computer such as a palm pilot, etc.). Each terminal 12, 14 has a respective display and input device (not shown) and is accessing the internet using a standard or proprietary communication protocol. There is no practical limit to the number of terminals that may be connected to the network.

The network 10 further includes at least one chief work station 18, at least one external agent 20 a data server 22, a transaction bridge 32 and a compliance bridge 34.

The network interconnection system 16 enables data flow between subscribers 12, 12′ observers 14, the chief workstation 18 and the external agents 20 preferably the network interconnection system 16 is URL-based system such as the internet, or other similar system capable of providing a bi-directional communication channel for the components of network 10. The system 16 may be implemented through conventional satellite, land, and local wired and wireless connections.

The database server 22 is a computing device that includes a web processing unit (WPU) 24, operating system 26, central processing unit 28, and data storage device 30.

The chief workstation 18 is a device arranged and constructed to perform processes unavailable to terminals 12, 14. For example, the chief workstation 18 is used to implement processes resident in the database server 22 including but not limited to the authorization of subscribers 12, performing data security, moderating investment communication, managing data storage, maintaining the transaction and compliance bridges 32, 34. The chief workstation 18 may include a multiplicity of components (not shown) configured to delegate control of active investing processes and information and includes a direct and secure link to the database server 22.

The transaction bridge 32and the compliance bridge 34 are used by the database-server 22 exchanges information with the external agent(s) 20.

The external agents 32 (only one agent being shown for the sake of clarity) provide standard services associated with securities trading, including current and historical information regarding certain specific securities and related intelligence, actual trading, record keeping, stockholder registrations and so forth. Several entities can provide these services as described below.

A computer-based external agent that can be used for exchanging information is Pershing Securities, a brokerage settlement and clearing agency. Pershing performs financial transactions electronically. Processes performed by Pershing include but are not limited to purchase and sale of securities, electronic account reporting and data store management. These services can be accessed by a subscriber 10 through the communication network 16 through transaction bridge 20.

Another preferred computer-based external agent that can be used to exchange information is Matrix Capital Group, inc., a NASD-qualified registered securities broker. By being part of the network 10, this group is capable of identifying potential customers, i.e., subscribers 10, enroll these customers in its programs and service selected resulting accounts. The group earns disclosed commissions for trades executed for the subscribers 12.

Other brokers similar to Pershing and Matrix Capital Group may also be used for trading and information exchange.

Another computer-based external agent connected to the network 10 may be a vendor of identity & signature verification services. These services may include tax id and status gathering, electronic review, electronic signature services. The services, notably signature verification, may be processed at the vendor site under private and secure conditions.

Other external agents may be used for services for corporate governance management including statutory filing services and public disclosure services. A preferred computer-based external agent which may be used as a source of information is the Securities and Exchange Commission (SEC), the principal securities market regulatory agency. Moreover, the network 10 may also be used to provide information to the SEC and to deposit with the SEC various documents required under present securities regulations. In this manner the network 100 is used to collect and format information for submission pursuant federal securities laws. The SEC and other external agents connected to the network may elect to monitor the activities of the subscribers thereof.

The invention further contemplates establishing observers as a class of subscriber. These observers may be connected to the network 16 to receive select information.

Software Configuration

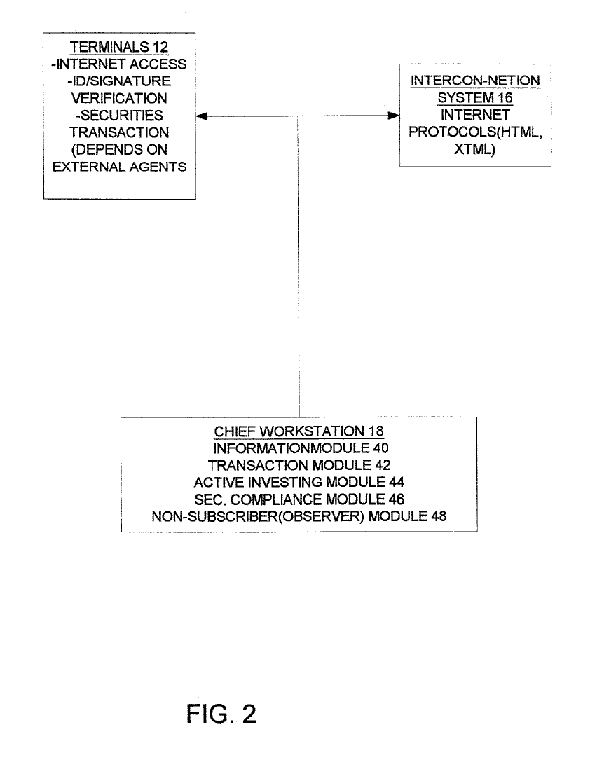

In the following description the software architecture routines incorporated into the various components described above are used to perform certain predefined processes as indicated somewhat diagrammatically in FIG. 2, the network 10 uses conventional and commercially available software which is modified and packaged or operated as separate and distinct modules, including ((an information module 40)), a transaction module 42, an active investing module 44, and a securities compliance module 46. The Chief workstation 18 uses these software modules to perform various processing and communications functions and services as described below. More specifically, the Chief workstation 18 controls the operation of network 10 with respect to access, content, screen menus, other processes, data storage and retrieval and establishment of links, as well as archiving and bridge activities.

The data base server 22 and bridges 32, 34 are operated by standard software that need not be described in greater detail.

Operation of the Active Investing Network

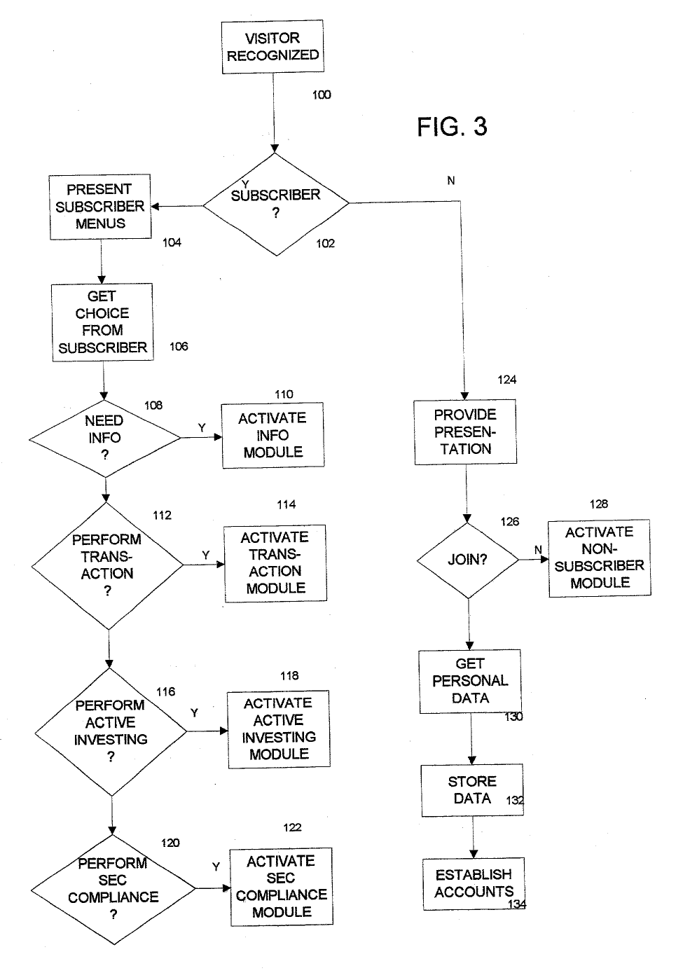

The general mode of operation of the active investing network 10 (or network for short) is first described in conjunction with the flow chart of FIG. 3. When a visitor first connects to the network 10, the does not know yet whether the visitor is a subscriber terminal 12 or non-subscriber terminal 14. In step 100 the network 10 first recognizes that a new visitor is connected to it. In step 102 the network determines whether the visitor is a subscriber or not. This may be done by asking the visitor and (if a subscriber) requesting a name and a password. Alternatively, other means maybe used to identify the visitor by using cookies or other similar means. If the visitor is a subscriber then in step 104, he is presented with a set of menus indicating a range of services available to him. In step 106 the choice of service is collected from the subscriber and analyzed to determine what the subscriber wants. For example, in step 108 if it is determined that the subscriber requires information, then the information module 40 is activated. Similarly in steps 112 and 114 the transaction module 42 is activated, in steps 116, 118 the active investing module 44 is activated and in steps 120, 122 the securities compliance module 46 is activated.

If the visitor is not a subscriber then in step 124 a presentation is provided to the visitor showing him the risks and advantages of becoming a subscriber. In step 126 the visitor is given the choice of joining the network as a subscriber 12. If he does not want to join, then in step 128 the non-subscriber module 48 is activated. This module allows the non-subscriber 14 to receive a subset of the services offered to the subscribers 12, such as some information through information module 40. Optionally, a non-subscriber may be granted his own id and password and be allowed to view activities and information stemming from the operation of the active investment module.

If the non-subscriber wants to join the network 10, then in step 130 personal data is obtained. In step 14, this data is stored, for example in storage 30. The network 10 distinguishes between subscribers and accounts, where the latter is enabled to perform investment transactions through the network. In step 134 various accounts are established for a subscriber through obtaining additional information relating to the identification and qualification of such account.

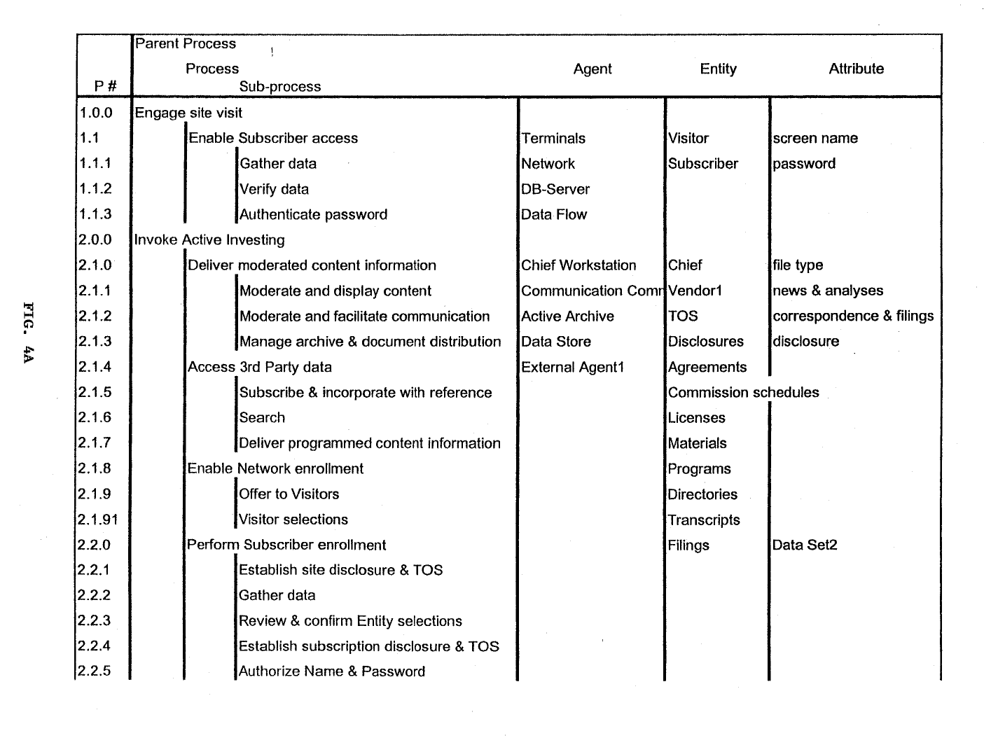

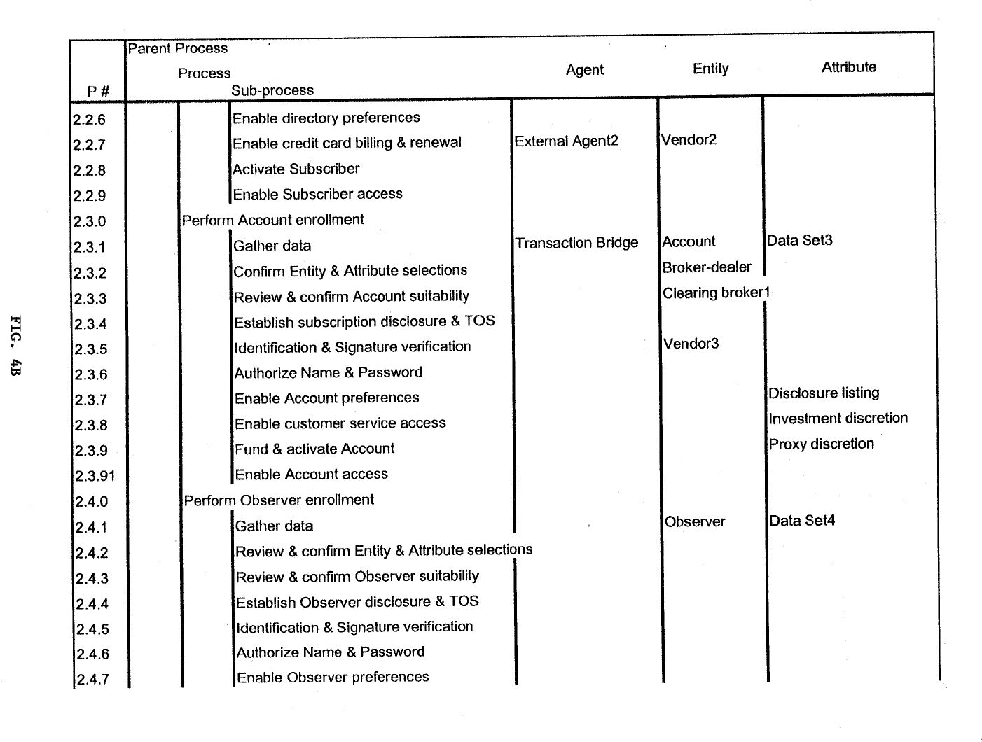

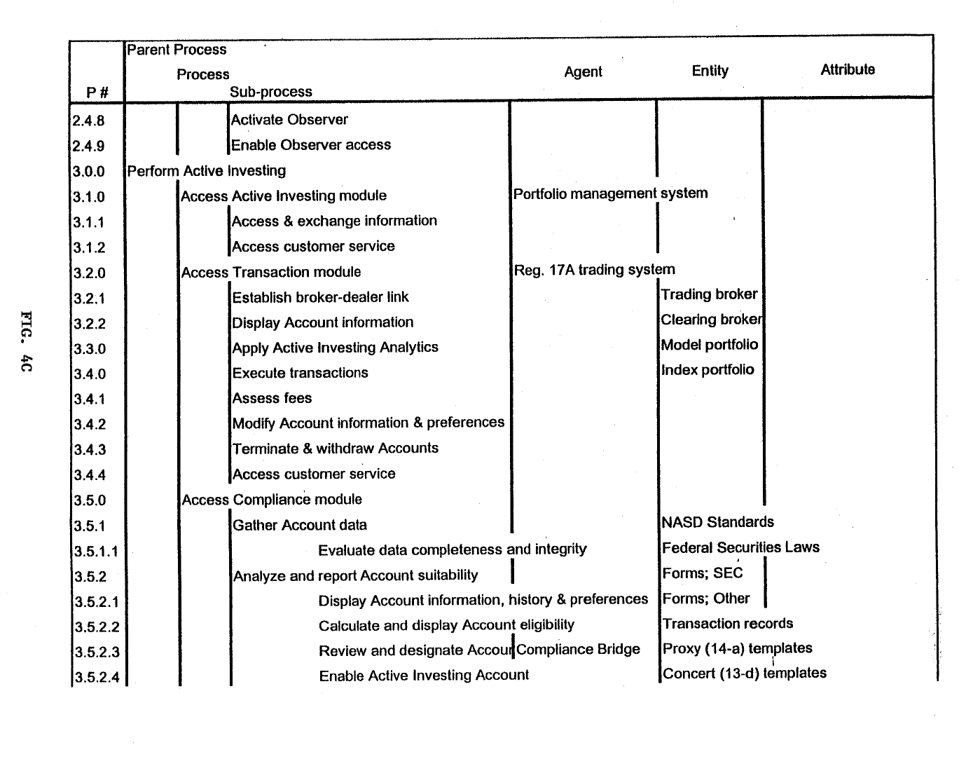

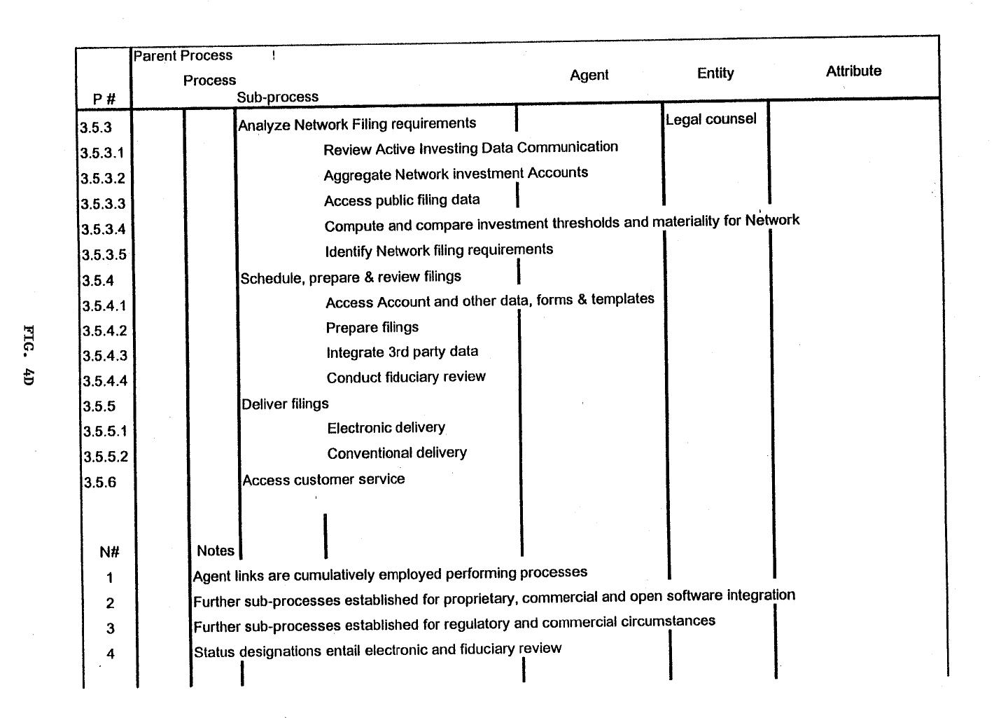

FIGS. 4a-c provide in a table form a listing of the various functions performed by the network 10, each function comprising of a comprehensive series of steps. In this table, the first column is used to designate or identify the steps, the second column provides a brief description of the respective step or process. The third column identifies the component or agent of the network that is used to perform or participates in the respective step.

More specifically, in FIG. 4a a visitor enters a visitor zone site of the network 10 (of FIG. 1) through appropriate menus as discussed above. The subscriber selects among these menus to activate the appropriate modules and agents. The menu screens may change to accommodate the subscriber information and selections. Steps 1.1.1-2.4.9 show details of the processes illustrated in general in FIG. 3 by steps 100-106 and 124-134. The network 10 moderates information exchange between and among visitors, subscribers, accounts, observers and at least one chief according to the terms of service established by the chief 12A. For example, steps 2.2.0 through 2.9.9 proffers the terms and means of enrolling in the active investing network. Step 2.3.0 through 2.3.9 show how the network conducts electronic account enrollment. As part of this process an account prospect accesses customer service and may use alternate means to complete the steps of account enrollment.

Subscribers access the URL through conventional internet means that form the communication system 16. Upon concluding login sequences, subscribers, including accounts and observers, may access the communication module that includes an active archive, communication command and links to external agents.

The active archive file is comprised of documents and data templates applicable to network operations and investment strategy. Such documents may include investment advisories submitted by the chief or subscribers, select correspondence between chief, subscribers and 3^{rd} parties, and filings performed by the chief on behalf of the network. The templates may include compilations of financial data formatted in a manner that permits subscriber manipulation and analyses. Also, the archive may provide hyperlinks to other active investing resources and external information.

The active archive is searchable by date, ticker, file type, topic, key word and other criteria. The active archive is moderated by a Chief, thereby providing a means of content oversight and fiduciary review. The Chief is obligated by the terms of service to appropriately display and make available information relating to investment risk and expenses.

The communication command includes email, threaded message board and chat utilities. As with the archive, communication options will be arrayed in a tabular menu permitting subscriber topic selection. Subscribers may access message boards and contribute comment and factual information thereto. Subscribers may access a subscriber directory to identify network participants and to selectively transmit email communications.

The chat utility may be used as an informal information exchange by chief and subscribers, as discussed in more detail below. Alternatively, topical chat sessions may be scheduled and include guest participants.

It is contemplated that the communication utilities are to be expanded to deliver streaming and or interactive programming and information services.

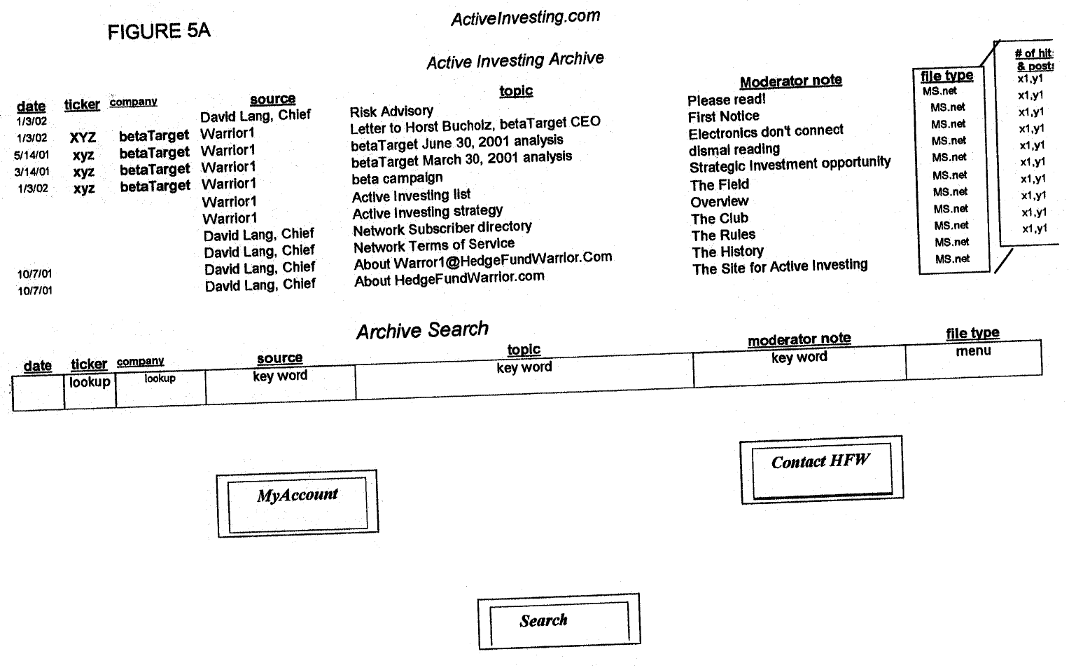

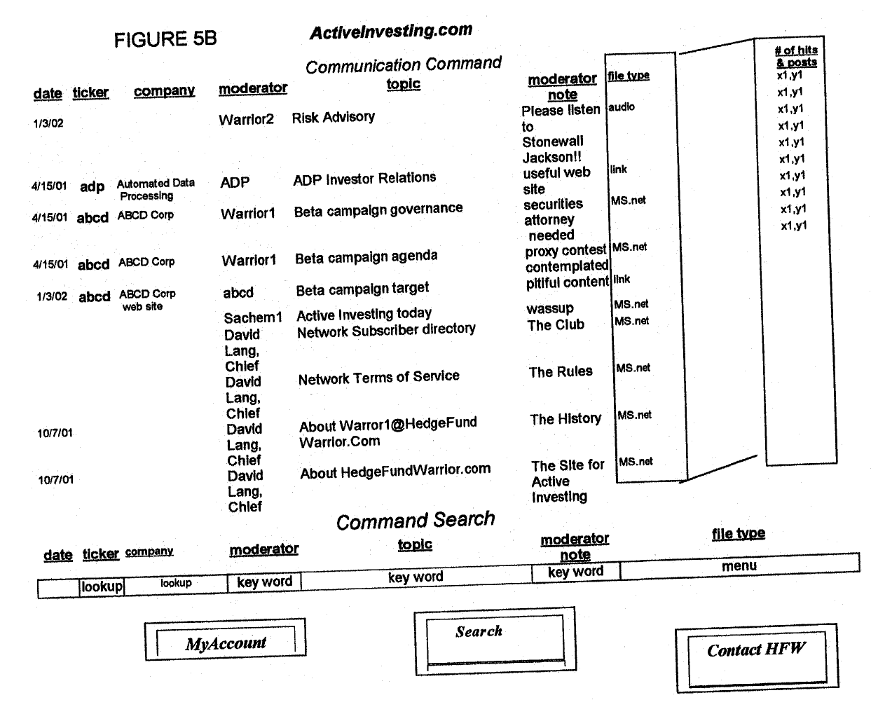

In a practical embodiment of active investing, a subscriber may access a moderated active list, a list of securities issuers in which the network may be active with respect to data gathering and or investment transactions. One such list is shown in the menu of FIGS. 5A and 5B. From the list, subscriber may link to public information about the issuer and to network information arising from network data gathering. Network information may include corporate and financial analyses, investment advice and strategy considerations.

The subscriber may use the active archive and communication command to further access topical information and may contribute facts and opinions through these mechanisms.

The information and advice derived through the active investing module may motivate a subscriber with an account to execute a securities transaction. Accordingly, the archive and command will contain prominent links to other active investing resources, notably the transaction module (MYACCOUNT) and a customer service facility.

Compliance

From a legal point of view, the active investing site may be deemed affiliated with a broker-dealer and subject to the standards and practices thereof. The securities compliance module of the active investing apparatus incorporates numerous features needed to implement an active compliance plan and satisfy certain statutory obligations arising from the requirements of rule 13d and rule 14a of the Securities Exchange Act of 1934.

Compliance requirements affect all brokerage and investment activities. In some instances, standards may be satisfied by the application of fiduciary judgment. Other instances require documentary action such as public filing and notice to issuers. In both instances, it is essential that the broker-dealer or affiliate maintain a comprehensive and accessible record of compliance-related actions. The securities compliance module provides such means.

Effective compliance relies on principled commitments. Active investing principles include a commitment to operating an open and disclosed network. Openness begins with the access. Active investing maintains free access to select documents and services. Additional materials, utilities and services are available upon payment of specified fees and satisfaction of eligibility and disclosure requirements. Further, openness dictates free access for qualifying regulatory personnel and active media.

Openness also includes an appetite for diverse investment information and discussion. Topics, including potential investment opportunities, may emerge through network dialogue.

Openness does not mean unconstrained. The terms of service obligate the subscriber to conduct dialogue in a responsible and legal manner.

Disclosure relates primarily to the identification of network participants. While subscriber communications will be conducted under selected screen names, subscribers will able to access a subscriber directory that will include select data including real names and professional & commercial affiliations.

Disclosure also presumes the discoverability of network communications and activities. As later described, subscribers and chief may elect to act in concert with respect to specific investment opportunities. This election may create an affirmative filing obligation. Subscribers must be aware that their messages and investment transactions may become a matter of public record.

The disclosable information includes data that may be required by filing requirements such as name, address, citizenship and professional & commercial affiliations. Select portions of this data are formatted and available for URL display.

The information is processed to:

gather and display extensive investor data

determine investor suitability

review investment objectives

evaluate wealth and income data

determine investor status

update investor information

obtain SEC clearance of marketing materials

conduct investor notifications

determine select filing requirements

compile active list

compile account transaction data

perform threshold and materiality tests

incorporate documents through hyperlink reference

format statutory filings

submit filings for professional review

collect & validate electronic signatures

execute electronic and conventional filing and notice

flag and restrict qualifying transactions

conduct regulatory dialogue

provide means of regulatory access

Subscription and account enrollment process incorporates extensive data gathering.

The data includes disclosable information that may be required by filing requirements such as name, address, citizenship and professional & commercial affiliations. Select portions of this data are formatted and available for URL display.

Steps 3.0.0 through 3.5.6 relate to the activation and operation of the various modules and correspond to steps 106-122 in FIG. 3. More specifically, steps 3.1.0-3.1.2 refer to the operation of the active investment module. When this module is activated, subscribers may elect to post new messages or respond to topic-related messages posted by others, perform a data search, access 3rd party information, deliver an electronic signature, make a customer service request, etc. in addition to the foregoing activities, accounts may access personal investment account information and transaction resources. In this manner, in a preferred embodiment, subscribers, accounts, observers and chief may share opinions and information about specific investments and corporate governance events

Elaborating on a preferred embodiment, subscribers, accounts, observers and chief may agree to act in concert with respect to designated securities investments and, as provided by the invention, disclose affiliations and transaction information. Further means of this activity may be offered by the chief workstation in cooperation with the network subscribers and vendors. For example, step 2.1.5 instructs the chief workstation 18 to subscribe to 3rd party news and program services for network distribution. The information may be presented in form of diverse media, including pictures, streaming video, sounds, etc.

Steps 3.2.0-3.4. show the operation of the transaction module to conduct an active investment transaction. As part of these operations, commercially available portfolio management software such as ADP/SIS's real-time brokerage accounting network to gather, process and display active investing menus together with conventional portfolio management tools.

The following provides a specific example of one use of active investing.

Subscribers access the URL through a conventional Internet portal. Once the network 10 is accessed, menus are presented which provide access to the active archive and the communication command. Through the former, the subscriber can identify topics of interest to the network and, through internal and external links, become familiar with the topic and the network's interest therein. Through the communication command, the subscriber may view, initiate and receive communications from subscribers and a chief 12A operating through a chief workstation 18.

For example, a subscriber 12A may select from one of the following archive topics:

Financial news & performance of ABC corp., including public filings, press releases and analyses related thereto.

Background of ABC corp, including segment businesses and competition ABC market data, including price performance and conventional valuation parameters

Discussion regarding corporate and private investment strategies

Disclosure of background of network and corporate participants

Means of satisfying securities compliance disclosure requirements

Obviously similar other information may be provided to the subscriber as well.

Based on information including the foregoing, subscriber may use the communication command to access the current data and other activities related to ABC corp. This may include moderated discussion threads dedicated to ABC corp. A specific chief 12A operating through a workstation 18 moderates network materials with respect to access, content and network control. The chief 12A fulfills fiduciary reporting obligations arising from the exchange of information and concerted transaction activity as discussed below.

Chief 12A will have previously authorized this thread utility and may have offered comment with respect to ABC valuation and or strategy. Such comment may note that a specific business segment of ABC is unprofitable and, in chief 12A's opinion, unlikely to become profitable under current management. Chief 12A may have offered an opinion that the sale or liquidation of the unprofitable segment is an appropriate strategy. Chief 12A may disclose a regulation 13d filing with respect to ABC, thereby indicating a willingness to influence or control the company.

Based on network and other information, subscriber 12A may share chief 12A's opinion and elect to initiate or review related transaction positions. This is effected by accessing links attached to the respective web pages being viewed by the subscriber 12A and is subject to previous completion of account enrollment and eligibility processes.

Alternately, subscriber 12A may use the communication command to get recent news and other opinions about ABC. Further, subscriber 12A may offer comment, ask questions, solicit advice from among network participants. Still further, the subscriber 12A may initiate direct and private (but discoverable) communications with other subscribers and/or other selected participants

The subscriber 12A may elect to access the network directory to identify and know the background of participants. The directory will be composed of selections of information gathered during subscription or account acquisition and will include true name, screen name, professional and non-commercial affiliations.

The subscriber 12A may further access the archive to know current positions and related transactions of participants. The subscriber 12A may also access the communication command to access participant comment history.

The subscriber 12A is in periodic contact with network through web access, emails and other communication means and will thereby have current information pertaining to an investment interest.

Another subscriber may join the network. This latter subscriber may have a “control or influence” position, as defined by reg. 13d, with respect to ABC. The network shall have the means to incorporate such information in compliance reporting.

A subscriber 12 may elect to promote an investment strategy different from ABC policy. Subscriber 12A may invite network participants to join such initiative. Subject to participation and agreement of chief 12A, network participants may elect to collaborate with subscriber 12A and chief 12A.

Network participants may jointly but subject to chief 12A approval, propose to effect an ABC policy change through active participation in corporate governance, the steps of which may include implementation of a proxy campaign. The rules and forms of a proxy campaign are prescribed by reg. 14a and include threshold & materiality tests, extensive disclosure obligations, and transaction limitations. The ToS and related agreements vest chief 12A with authority and obligation to satisfy and impose fiduciary requirements arising from reg. 14a.

It is readily seen by those familiar with investment finance that active investing features are useful in conducting a proxy campaign. The opportunity to form and participate in an active investing network augments and leverages participant knowledge by engaging coalition information and voting support.

Further, the pre-meditated collection of investor data and qualifications simplifies and accelerates filing processes. Such information is available for preliminary, definitive and amended filing purposes. Still further, the ToS establishes conditions under which chief 12A can fulfill fiduciary obligations arising from statements of investment purpose, material investment positions and service of process requirements.

The securities compliance module of active investing offers utilities for the scheduling, preparation, review, disclosure and filing of proxy materials and solicitation documents. Applying these resources together with trading & position reports accessible through the transaction module provides chief 12A with the principal means of compliance with reg. 14a.

Chief 12A periodically reviews network information to determine securities filing requirements. Such information includes filing history, transaction activities & positions, and site content. Chief 12A uses network resources to gather, collate, compute, redact, format, and disseminate filing content. Chief 12A may further use the communication command to access professional advice and services.

In a preferred embodiment, subscriber 12A retains full and complete discretion with respect to account investment activities and may at any time increase or dispose of any investment position properly held within an account; may terminate and transfer all or part of any such account; and may abstain, concur or oppose any governance initiative proposed by network participants.

The foregoing combination of information and identification exchange, transaction processing and compliance support is a new and useful configuration, also described as active investing and delivered through the network & method disclosed herein. Active investing also includes disclosure and privacy policies prescribed by the network terms of service (ToS) and account-related brokerage or investment management agreements.

Step 3.4.0 initiates NASD-compliant securities transactions. As part of this step conventional electronic brokerage, clearing & reporting functions are also completed.

Step 3.4.2 provides for updating account information and preferences.

If necessary, a subscriber 12A or account may be provided access to an online customer service representative in step 3.4.4. Steps 3.2.0-3.4.4 may include additional or alternate processes as well for completion of transactions.

Network investment activities may create affirmative public filing obligations arising from the securities act of 1933 and the securities exchange act of 1934. The securities compliance module 46 is adapted to identify events that require compliance and to generate and (optionally) to deposit the required fillings. This feature is particularly useful.

A chief operating through a chief workstation 18 and associated terminals may accesses the data stored by the data server 22 and perform various compliance activities, including but not limited to investor suitability evaluations, supervised account communication, transaction reporting and statutory filing, using predetermined rules.

The securities compliance module 46 of the active investing network incorporates features needed to implement an active compliance plan and satisfy select statutory obligations. The module, however, is not inclusive of all reporting requirements. By example, an active investing site may be operated by registered broker-dealer and, as such, required to make public periodic reports concerning financial activities and positions; the module does not include such broker-dealer financial reporting.

The network 10 maintains an Active List including issuer names and identifiers. The securities compliance module 46 includes processes useful for determining the need for filing with respect to investment transactions or positions with respect to such issuers.

By way of a first example, the module can compare an aggregate network investment position with the threshold reporting requirement specified in Regulation 13D. This is achieved by gathering information relating to the number of shares outstanding of listed issuers and the number of such shares beneficially owned by network subscribers and computing the percentage ownership thereof. The number of shares outstanding can be obtained from public databases, while the number beneficially owned can be compiled from data obtainable through the transaction module. A computed percentage exceeding 5% indicates a requirement for current and subsequent public filings. Similar processes are used to identify and filter trades contrary to rule 13D.

Rule 13D also requires that securities holders investing with the purpose or effect of changing or influencing control of the issuer file a statement in connection thereto. Information available through the active archive, communication command and transaction module enable the chief to determine the applicability of the rule and to compile the schedules required therefore.

Compliance with rule 13D is fundamental to the operation of the Active Investing network. While the practices and substance of compliance are matters of professional judgment, the present active investing network provides utilities adaptable to current and future disclosure obligations. In addition to addressing the tangible data and filing requirements, the use of active investing services establishes both the intention and presumption of effective compliance

The securities compliance module includes means of preparing the filing, including templates of the sec-prescribed forms, rules and instructions; access and means of collating and formatting subscriber 12A names and associated data with transactions and investment positions; and a means of communicating with subscriber 12As to update and verify information with respect to such filing. The module may include investor identification & signature verification services. The module further provides a communication bridge able to perform electronic and conventional filing and notices as specified by rule. Details of how the filling requirements are generated and submitted are shown in FIGS. 4B and 4C, steps 3.5.0-3.5.6. In step 3.5.1 the account information acquired by a subscriber 12A through the transaction module is collated. Step 3.5.2 displays relevant account information in a manner that enables a chief to review and designate account eligibility with respect to securities transactions, thereby exercising account compliance.

Step 3.5.3 aggregates and processes investment information from network accounts and designated 3rd-parties, thereby enabling a chief to determine filing requirements arising from foregoing investments.

Step 3.5.4 enables a chief to prepare and review proposed filings. As part of this procedure, the account data is accessed, together with preselected forms, templates and schedule information related to the subject filling. Moreover, a report of transaction limitations and disclosures requirements incident to the filing may also be generated.

Once a filling is completed a step 3.5.5 is used to deliver the filling through the transaction bridge 32 a manner prescribed by statute, regulation and industry practice.

While the invention has been described in terms of preferred embodiments, those skilled in the art would recognize that the invention could be practiced, equivalently or with modification, within the spirit and scope of the attached claims.

I claim:

1. A network for gathering and processing information between multiple subscribers through a communication network, comprising:
a plurality of terminals, each terminal being associated with a subscriber and connected to said communication network; and
a chief workstation associated with the communication network and adapted to selectively provide a plurality of services to subscribers through said terminals, including a security transaction, information exchange between subscribers and preparation of a public filling.

2. The network of claim 1 wherein said chief workstation is adapted to prepare and deliver said public filling through said communication network.

3. The network of claim 1 wherein said communication network is connected to at least one external agent, and wherein said chief workstation is adapted to obtain information from said external agent and deliver said information to said terminals.

4. The network of claim 1 wherein said communication network is connected to an external agent adapted to perform electronic security transactions, wherein said chief workstation is adapted to enable security transactions by said subscribers through said external agents.

5. An active investing network comprising:
a plurality of subscriber terminals adapted to provide access to the network by respective subscribers;
common communication services adapted to receive and display documents and messages from and among subscribers;
a chief terminal adapted to generate control commands to monitor and moderate said communication services;
said chief terminal, communication services and subscriber terminals being constructed and arranged to provide exchange of information about investments or securities.

6. The network of claim 5 further comprising a bridge adapted to exchange information with an external agent.

7. The network of claim 5 further comprising a compliance module adapted to monitor total assets of said subscribers associated with a security issuer and to determine if a set of rules require a governmental filling regarding said security issuer.

8. The network of claim 5 wherein said compliance module is further adapted to generate a filling document based on said total assets and said set of rules

9. The network of claim 8 further comprising a bridge adapted to deposit said document with a governmental agency.

10. The network of claim 5 further comprising a bridge to an external agent.

11. The network of claim 10 wherein said bridge is adapted to provide securities transactions between said subscribers and said external agent.

12. The network of claim 5 further comprising observer terminals to accommodate observers that can observe data on said system but cannot participate in active investing transactions.

13. A method of performing multiple active investment transactions comprising:
providing a plurality of subscriber terminals adapted to exchange information over a standard communication system;
providing common communication services adapted to receive and display messages from and among said subscribers regarding specific securities; and
providing a chief terminal adapted to monitor and moderate said messages of said communication services.

14. The method of claim 13 further comprising obtaining additional information regarding securities by said chief terminal and transmitting said additional information from and among subscribers.

15. The method of claim 14 further comprising monitoring assets of said subscribers associated with a particular investment security to determine if a set of rules are applicable to said assets.

16. The method of claim 15 further comprising providing a compliance module to determine if said set of rules are applicable

17. The method of claim 16 further comprising collecting data from various data sources and generating a filling document when said set of rules are applicable.

18. The method of claim 17 further depositing said filling document with a receiving agency.

19. The method of claim 18 further comprising depositing said filling document electronically.

20. The method of claim 13 further comprising performing investment transactions by said subscribers through an external agent.
